(19) United States
(12) Patent Application Publication
(10) Pub. No.: US 2022/0040955 A1
(43) Pub. Date: Feb. 10, 2022

(54) COMPOSITE BELT, BAND SEALER AND BAND SEALING METHOD

(71) Applicant: Cryovac, LLC, Charlotte, NC (US)

(72) Inventors: Giulio Benedetti, Solbiate Arno (Varese) (IT); Stefan Landolt, Obernau (CH); Peter Thürig, Eich (CH); Peter Schnurrenberger, Steinhausen (CH); Peter Mueller, Goldau (CH)

(21) Appl. No.: 17/291,033

(22) PCT Filed: Jun. 12, 2019
(86) PCT No.: PCT/EP19/65306

§ 371 Date: May 4, 2021

(30) Foreign Application Priority Data
Nov. 6, 2018 (EP) 18204541.9

(51) Int. Cl. B32B 7/022; B65B 51/18; B65B 51/32; B32B 7/09; B32B 7/12; B32B 27/32; B29C 65/00

(52) U.S. Cl. CPC B32B 7/022; B65B 51/18; B65B 51/32; B32B 7/09; B32B 7/12; B32B 27/322; B29L 2031/7128; B29C 66/849; B29C 66/43121; B29C 66/0342; B32B 2307/302; B32B 2307/538; B29C 66/83423

(57) ABSTRACT

A composite belt assembly for a band sealer is provided. The composite belt assembly comprises a belt comprising a main belt; a first layer; and a second layer; wherein the first layer is arranged in contact with the main belt, preferably between the second layer and the main belt; and the first layer includes an attachment portion, configured to contact the main belt and the second layer. There is also provided a band sealer comprising a composite belt assembly and a packaging line comprising the band sealer. There is further provided a method for heat sealing a package, comprising providing a composite belt assembly, gripping a bag neck of the package using the composite belt assembly, guiding the bag neck of the package along a movement plane using the composite belt assembly providing a sealing element configured for heat sealing a plastic material of the bag neck, and applying heat to at least part of the bag neck through the first layer of the composite belt assembly using the sealing element.

### TECHNICAL FIELD

The present invention relates to a process and apparatus for sealing packages in packaging applications. In particular, the present invention relates to a composite belt, a band sealer using said composite belt and a process and apparatus for band-sealing packages in packaging applications.

### BACKGROUND ART

A packaging apparatus can be used to package a product, for example a food product. The product can be a bare product or a product pre-loaded onto a tray. A tube of plastic wrap can be continuously fed through a bag/package forming, filling and sealing apparatus. The film and the product are joined, for example the product is deposited on the film or the film is wrapped around the product. In some examples, the bare product is fed through an infeed belt. A tube is created around the product by joining together and sealing opposite longitudinal edges of the film. Alternatively, the product is placed in the tube and a leading edge (at the downstream end) of the packaging material is sealed. Then the tube is sealed at the trailing edge (at the upstream end) of the package and is severed from the continuously moving tube of packaging material.

In some solutions, the tube can be provided as a tube, or be formed from two films or webs sealed longitudinally at two longitudinal edges, or from a single film that is folded over and sealed along its longitudinal edges. In other embodiments, products are loaded into pre-formed bags, which are then supplied to an evacuation station and to a sealing station or to a combined evacuation/sealing station. Sealing bars or sealing rolls can be used to create seals in the packaging material. If sealing bars are employed, a lower bar and an upper bar may be moved with respect to one another in order to contact each other while squeezing the packaging material between the bars and providing one or more seals, for example based on heat-sealing.

In some examples, packages are placed on a conveyor belt in an orientation where an unsealed end of the package, for example the open edge of a bag holding a product, is located laterally on the side of the conveyor with respect to a main movement direction of the conveyor. The open ends of the packages can then be fed through a band sealer, which performs, for example, heat sealing of the package material. The seals are typically transversally extending regions, stripes, or bands of packaging material that have been processed (e.g. heat-treated) to provide a seal between the inside of the packaging and the environment.

Band sealers for packaging applications are typically provided with a band sealer mechanism in which a package is fed between grip belts, e.g. a top belt and a bottom belt, which are configured to hold and guide a portion of the package during sealing. Sealing is typically achieved by means of sealing elements that engage the package material while it is held by the grip belts. This can involve two sets of grip belts (e.g. two upper and two lower belts) guided along on either side of the sealing elements.

In some cases, a band sealer may include a total of four grip belts, two top belts and two bottom belts, arranged opposite the two top belts, between which the package is held. In such cases, the sealing/cooling elements may be located between the two belts. In some cases, a Teflon tape may be employed in order to reduce the friction between the packaging material and the sealing/cooling bars.

BR 202013004024-5 U2 describes a sealing apparatus, which employs two opposing belts between which a plastic film of a package can be fed into and through a sealing unit. The sealing unit includes heating elements which are configured to heat the plastic film of the package to be sealed through a pair of endless Teflon tapes being disposed between the heating units and the plastic film. The two opposing belts and the Teflon tape are operated independently from one another.

During sealing and/or subsequent cooling, the grip belts are required to hold the package material with sufficient strength in order to prevent the package material from shrinking and/or deforming. Shrinking and/or deformation typically occurs during the application of heat and/or by the friction caused between the sealing/cooling elements and the package material, thereby potentially resulting in creases, pleats, or otherwise deformed packages. Any shrinking or deformation may negatively affect the package appearance, quality, and/or the tightness of the seal and, thus, may render the package unfit for distribution.

An aim of the present invention is to provide a method and apparatus for sealing packages which avoids one or more of the above-identified issues.

### SUMMARY OF INVENTION

According to the invention, in a 1^{st} aspect there is provided a composite belt assembly for a band sealer. The composite belt assembly comprises a belt, the belt comprising a main belt, a first layer, and a second layer. The first layer is arranged in contact with the main belt, preferably between the second layer and the main belt. The first layer includes an attachment portion, configured to contact the main belt and the second layer.

In a 2^{nd} aspect according to the 1^{st} aspect, the first layer further includes an extended portion, configured to laterally extend beyond the main belt and the second layer with respect to a longitudinal extension of the main belt.

In a 3^{rd} aspect according to any one of the preceding aspects, the first layer is fixedly attached to the main belt. Preferably, the first layer is fixedly attached to the main belt by heat bonding, gluing, and/or stitching.

In a 4^{th} aspect according to any one of the preceding aspects, the second layer is fixedly attached to the first layer. Preferably, the second layer is fixedly attached to the first layer by heat bonding, gluing, and/or stitching.

In a 5^{th} aspect according to any one of the preceding aspects, the main belt exhibits a shape of an endless loop.

In a 6^{th} aspect according to the preceding aspect 5, the main belt has an inner surface and an outer surface with respect to the shape of the loop; and the first layer is arranged on the outer surface of the main belt.

In a 7^{th} aspect according to any one of the preceding aspects, the first layer includes polytetrafluoroethylene (PTFE), Teflon, a Teflon band, Teflon tape, or Teflon film.

In an 8^{th} aspect according to any one of the preceding aspects, the second layer includes Silicone, preferably wherein the second layer includes Linatex from Forbo Siegling.

In a 9^{th} aspect according to any one of the preceding aspects, the belt further comprises third layer attached to the main belt on a surface of the main belt opposite the first layer.

In a 10^{th} aspect according to the preceding aspect 9, the third layer is fixedly attached to the main belt. Preferably, the third layer is fixedly attached to the main belt by heat bonding, gluing, and/or stitching.

In an 11^{th} aspect according to any one of the two preceding aspects 9 and 10, the third layer includes a mesh structure, for example Eco-mesh coating of Forbo Siegling. Preferably, the third layer is configured to provide the main belt with a low friction surface.

In a 12^{th} aspect according to any one of the preceding aspects, the composite belt assembly further comprises: an additional main belt; and an additional second layer. The first layer is further arranged between the additional second layer and the additional main belt; and

the first layer includes an additional attachment portion on an opposite side of the first layer with respect to the attachment portion, the additional attachment portion being configured to contact the additional main belt and the additional second layer and the extended portion being configured to laterally extend between the main belt and the additional main belt.

In a 13^{th} aspect there is provided a band sealer comprising a composite belt assembly according to any one of the preceding aspects from 1 to 12.

In a 14^{th} aspect according to the preceding aspect 13, the band sealer further comprises: sealing blades, cooling blades, and

voiding rolls. Preferably, the band sealer further comprises pressure rolls configured to compress a bag neck of a package.

In a 15^{th} aspect there is provided a packaging line comprising a band sealer in accordance with any one of aspects 13 and 14. The packaging line comprises one or more of: a feeding station configured to provide packages to the band sealer; a conveyor belt configured to convey the packages along a main movement direction; and, optionally, a vacuum station configured to evacuate the packages and/or to provide the packages with a controlled internal atmosphere.

In a 16^{th} aspect, there is provided a method for heat sealing a package, comprising: providing a composite belt assembly in accordance with any one of aspects 1 to 12; gripping a bag neck of the package using the composite belt assembly; guiding the bag neck of the package along a movement plane using the composite belt assembly; providing a sealing element configured for heat sealing a plastic material of the bag neck; and applying heat to at least part of the bag neck through the first layer of the composite belt assembly using the sealing element.

In a 17^{th} aspect according to the preceding aspect 16, the method further comprises: providing a cooling element; and cooling the at least part of the bag neck through the first layer of the composite belt assembly using the cooling element.

In an 18^{th} aspect according to any one of the preceding aspects 16 and 17, the method further comprises: providing a voiding element; and voiding the at least part of the bag neck through the first layer of the composite belt assembly using the voiding element. The voiding comprises reducing, removing, or expelling foreign substance from between adjacent layers of packaging material at the at least part of the bag neck.

In a 19^{th} aspect according to any one of the preceding aspects 16 to 18, the method further comprises: providing a pressing element; and compressing the at least part of the bag neck through the first layer of the composite belt assembly using the pressing element.

In a 20^{th} aspect according to any one of the preceding aspects 16 to 19, the method further comprises: providing a vacuum station; and substantially evacuating the package before applying heat to the at least part of the bag neck.

A 21^{st} aspect concerns a composite belt assembly for a band sealer (100), comprising a belt (160, 160′), the belt (160, 160′) comprising: a main belt (162, 162′); a first layer (166, 166′); and a second layer (168, 168′).

In a 22^{nd} aspect according to the 21^{st} aspect the first layer (166, 166′) is arranged in contact with at least one of the main belt (162, 162′) and the second layer (168, 168′).

In a 23^{rd} aspect according to any one of the preceding 2 aspects the first layer (166, 166′) includes an attachment portion (166a, 166a′) connected to at least one of the main belt (162, 162′) and the second layer (168, 168′).

In a 24^{th} aspect according to any one of the preceding 3 aspects the first layer (166, 166′) further includes an extended portion (166e, 166e′) configured to laterally extend beyond the main belt (162, 162′) and the second layer (168, 168′) with respect to a longitudinal extension of the main belt (162, 162′).

In a 25^{th} aspect according to any one of the preceding 4 aspects the first layer (166, 166′) is fixedly attached to the main belt (162, 162′) by one or more of heat bonding, gluing, and stitching.

In a 26^{th} aspect according to any one of the preceding 5 aspects the first layer (166, 166′) is fixedly attached to the second layer (168, 168′) by one or more of heat bonding, gluing, and stitching.

In a 27^{th} aspect according to any one of the preceding 6 aspects the second layer (168, 168′) is fixedly attached to the first layer (166, 166′) by one or more of heat bonding, gluing, and/or stitching.

In a 28^{th} aspect according to any one of the preceding 7 aspects the main belt (160, 160′) exhibits a shape of an endless loop, wherein the main belt (160, 160′) has an inner surface and an outer surface with respect to the shape of the endless loop; and wherein one of the second layer (168, 168′) and of the first layer (166, 166′) is arranged on the outer surface of the main belt (162, 162′).

In a 29^{th} aspect according to the 28^{th} aspect the first layer is directly attached to the outer surface of the main belt and wherein the second layer is directly attached to an outer surface of the first layer.

In a 30^{th} aspect according to the 28^{th} the first layer is directly attached to the outer surface of the main belt, optionally at a laterally extending portion (162c) of a base body (162a) of the main belt, and wherein the second layer is directly attached to an outer surface of the main belt, optionally at a location adjacent said laterally extending portion.

In a 31^{st} aspect according to the 28^{th} the first layer is directly attached to the outer surface of the main belt, at a laterally extending portion (162c) of a base body (162a) of the main belt, and wherein the second layer is directly attached to an outer surface of the main belt, optionally at a location adjacent said laterally extending portion.

In a 32^{nd} aspect according to the 28^{th} the first layer is directly attached to the outer surface of the main belt, at a laterally extending portion (162c) of a base body (162a) of the main belt, and wherein the second layer is directly attached to an outer surface of the main belt, at a location adjacent said laterally extending portion.

In a 33^{rd} aspect according to the 28^{th} the second layer is directly attached to the outer surface of the main belt and the first layer is directly attached to an outer surface of the second layer.

In a 34^{th} aspect according to the 28^{th} the second layer is directly attached to the outer surface of the main belt and the first layer is directly attached to an inner surface of the second layer.

In a 35^{th} aspect according to any one of the preceding aspects from the 21^{st} to the 34^{th} the first layer comprises a thin elongated web and wherein the second layer comprises an elongated band with thickness greater than a thickness of the first layer elongated web.

In a 36^{th} aspect according to any one of the preceding aspects from the 21^{st} to the 35^{th} the first layer has a thickness of between 0.05 mm and 0.4 mm.

In a 37^{th} aspect according to any one of the preceding aspects from the 21^{st} to the 36^{th} the first layer has a thickness of between 0.1 mm and 0.2 mm.

In a 38^{th} aspect according to any one of the preceding aspects from the 21^{st} to the 37^{th} wherein the second layer has a thickness of between 0.5 mm and 2 mm.

In a 39^{th} aspect according to any one of the preceding aspects from the 21^{st} to the 38^{th} wherein the second layer has a thickness of between 0.75 mm and 1.5 mm.

In a 40^{th} aspect according to any one of the preceding aspects from the 21^{st} to the 39^{th}, the composite belt assembly further comprises an additional second layer (168, 168′) laterally spaced from said second layer (168, 168′).

In a 41^{st} aspect according to the preceding aspect the second layer and the additional second layer are elongated bands extending in parallel along the entire belt assembly.

In a 42^{nd} aspect according to the preceding aspect the second layer and the additional second layer are elongated bands extending in parallel along the entire belt assembly.

In a 43^{rd} aspect according to any one of the preceding 3 aspects the first layer (166, 166′) includes an additional attachment portion (166a, 166a′) on an opposite side of the first layer (166, 166′) with respect to the attachment portion (166a, 166a′), the additional attachment portion being connected to the additional second layer (168, 168′), and wherein the extended portion (166e, 166e′) laterally extends between the second layer and the additional second layer.

In a 44^{th} aspect according to any one of the preceding 4 aspects the second layer and the additional second layer (168, 168′) are both attached to an outside surface of the first layer (166, 166′), which has an inside surface attached to the main belt (162, 162′).

In a 45^{th} aspect according to any one of the preceding aspects from the 40^{th} to the 43^{rd} the second layer and the additional second layer outer surfaces are both attached to an inside surface of the first layer, wherein the second layer and the additional second layer inside surfaces are attached to the main belt (162, 162′).

In a 46^{th} aspect according to any one of the preceding 3 aspects the composite belt assembly further comprises an additional main belt (162, 162′).

In a 47^{th} aspect according to the preceding aspect the additional attachment portion (166a, 166a′) of the first layer (166, 166′) contacts and is attached to the additional main belt (162, 162′).

In a 48^{th} aspect according to any one of the preceding 2 aspects the additional attachment portion (166a, 166a′) of the first layer (166, 166′) contacts and is attached to the additional second layer (168, 168′).

In a 50^{th} aspect according to the preceding aspect the first layer (166, 166′) is arranged between the additional second layer (168, 168′) and the additional main belt (162, 162′).

In a 51^{st} aspect according to the preceding aspect the additional attachment portion (166a, 166a′) of the first layer (166, 166′) contacts the additional main belt (162, 162′) and the additional second layer (168, 168′).

In a 52^{nd} aspect according to any one of the preceding 2 aspects the extended portion (166e, 166e′) laterally extends between the main belt (162, 162′) and the additional main belt (162, 162′).

In a 53^{rd} aspect according to any one of the preceding aspects the first layer includes polytetrafluoroethylene (PTFE), Teflon, a Teflon band, Teflon tape, or Teflon film.

In a 54^{th} aspect according to any one of the preceding aspects the first layer provides higher heat conduction than the second layer.

In a 55^{th} aspect according to any one of the preceding aspects the first layer provides for lower static friction on a smooth plastic surface than the second layer.

In a 56^{th} aspect according to any one of the preceding aspects the second layer includes Silicone, preferably wherein the second layer includes Linatex from Forbo Siegling.

In a 57^{th} aspect according to any one of the preceding aspects the belt assembly (160, 160′) wherein the composite belt further comprises a third layer (164, 164′) attached to the main belt (162, 162′) on an inner surface of the main belt.

In a 58^{th} aspect according to any one of the preceding aspects the belt assembly (160, 160′) further comprises a third layer (164, 164′) attached to the main belt (162, 162′) opposite the first layer (166, 166′).

In a 59^{th} aspect according to any one of the preceding 2 aspects the third layer (164, 164′) is fixedly attached to the main belt (162, 162′).

In a 60^{th} aspect according to the preceding aspect the third layer (164, 164′) is fixedly attached to the main belt (162, 162′) by heat bonding, gluing, and/or stitching.

In a 61^{st} aspect according to any one of the preceding 4 aspects the third layer (164, 164′) includes a mesh structure, for example Eco-mesh coating of Forbo Siegling.

In a 62^{nd} aspect according to any one of the preceding 5 aspects the third layer (164, 164′) provides the main belt (162, 162′) with a low friction surface, wherein the third layer (164, 164′) provides for lower static friction on a smooth metal surface than the main belt (162, 162′).

A 63^{rd} aspect concerns a band sealer (100) comprising a composite belt assembly (160, 160′) according to any one of the preceding aspects from the 21^{st} aspect to the 63^{rd} aspect.

In a 64^{th} aspect according to the preceding aspect the band sealer (100) is configured to receive, along a main movement plane (70), packages (80) containing one or more products to be packaged.

In a 65^{th} aspect according to any one of the preceding 2 aspects the band sealer comprises: sealing elements (130, 130′) arranged opposite one another on either side of the movement plane (70) of the packages 80.

In a 66^{th} aspect according to any one of the preceding 3 aspects the band sealer comprises: cooling elements (140, 140′) arranged opposite one another on either side of the movement plane (70) of the packages 80.

In a 67^{th} aspect according to any one of the preceding 4 aspects the band sealer comprises voiding devices (120, 120′) configured to apply pressure to a region of the package (80) in order to expel, remove, or reduce any foreign matter from said region to be sealed.

In a 68^{th} aspect according to the preceding aspect the voiding devices comprise pressure rolls configured to compress a bag neck (82) of a package (80).

In a 69^{th} aspect according to any one pf the preceding 6 aspects the band sealer has one or more guides (150, 150′) configured to respectively guide one or more belt assemblies (160, 160′).

In a 70^{th} aspect according to the preceding aspect and using the composite belt of any one of aspects from the 57^{th} aspect to the 62^{nd} aspect the third layer (164, 164′) of each belt assembly provides for lower static friction on the inner surface of the respective guide compared the static friction that would have been generated on the inner surface of the same respective guide by the main belt (162, 162′) without the third layer.

In a 71^{st} aspect according to any one of the preceding 2 aspects wherein the band sealer has oppositely facing guides (150, 150′), each guide of the two opposite guides being vertically movable with respect to the opposite guide.

A 72^{nd} aspect concerns a packaging line comprising a band sealer (100) in accordance with any one of aspects from the 63^{rd} aspect to the 71^{st} aspect, the packaging line comprising one or more of:

a feeding station configured to provide packages (80);

at least one conveyor, in particular a conveyor belt, (71) configured to convey the packages (80) along a main movement direction (60) from the feeding station to the band sealer; and, optionally,

a vacuum station configured to evacuate the packages (80) and/or to provide the packages (80) with a controlled internal atmosphere.

A 73^{rd} aspect concerns a method (300) of heat sealing a package (80), comprising:

providing (302) a composite belt assembly (160, 160′) in accordance with any one of aspects from the 21^{st} aspect to the 62^{nd} aspect or a band sealer in accordance with any one of aspects from the 63^{rd} aspect to the 71^{st} aspect;

gripping (304) a bag neck (82) of the package (80) using the composite belt assembly (160, 160′);

guiding (306) the bag neck (82) of the package (80) along a movement plane (70) using the composite belt assembly (160, 160′);

providing (308) a sealing element (130, 130′) configured for heat sealing a plastic material of the bag neck (82); and

applying (310) heat to at least part of the bag neck (82) through the first layer (166, 166′) of the composite belt assembly (160, 160′) using the sealing element (130, 130′).

In a 74^{th} aspect according to the preceding aspect, the method further comprises:

providing a cooling element (140, 140′); and

cooling the at least part of the bag neck (82) through the first layer (166, 166′) of the composite belt assembly (160, 160′) using the cooling element (140, 140′).

In a 75^{th} aspect according to any one of the preceding 2 aspects, the method further comprises:

providing a voiding element (120, 120′); and

voiding the at least part of the bag neck (82) through the first layer (166, 166′) of the composite belt assembly (160, 160′) using the voiding element (140, 140′); wherein

the voiding comprises reducing, removing, or expelling foreign substance from between adjacent layers of packaging material at the at least part of the bag neck (82).

In a 76^{th} aspect according to any one of the preceding 3 aspects, the method further comprises:

providing a pressing element; and

compressing the at least part of the bag neck (82) through the first layer (166, 166′) of the composite belt assembly (160, 160′) using the pressing element.

In a 77^{th} aspect according to any one of the preceding 4 aspects, the method further comprises:

providing a vacuum station; and

substantially evacuating the package (80) before applying (310) heat to the at least part of the bag neck (82).

Advantages of the band sealer and of the method for heat sealing a package include that the packaging material can be held in place properly in order to reduce or eliminate any shrinking and/or deformation of the packaging material.

Further advantages of the band sealer and of the method for heat sealing a package include that the heat sealing and/or cooling may be achieved more efficiently, due to sufficiently close contact and/or due to sufficient contact pressure between the sealing/cooling elements and the packaging material.

Further advantages of the band sealer and of the method for heat sealing a package include that the tension on the packaging material during heat sealing and/or cooling may be reduced or minimized, thereby improving seal quality.

### BRIEF DESCRIPTION OF DRAWINGS

FIG. 1 schematically shows a side view of a band sealer mechanism in accordance with embodiments of the present invention;

FIG. 2 shows a cross section of the band sealer mechanism shown in FIG. 1 in accordance with embodiments of the present invention;

FIG. 2A shows a detailed view of a cross section of the band sealer mechanism shown in FIG. 1 in accordance with embodiments of the present invention;

FIG. 2B shows a detailed view of a cross section of the band sealer mechanism shown in FIG. 1 in accordance with a first embodiment of the present invention;

FIG. 2C shows a detailed view of a cross section of the band sealer mechanism shown in FIG. 1 in accordance with a second embodiment of the present invention;

FIG. 2D shows an isometric view of a composite belt assembly for use in a band sealer mechanism as shown in FIG. 1 in accordance with a third embodiment of the present invention;

FIG. 2E shows a detailed view of a cross section of the composite belt assembly shown in FIG. 2D in accordance with the third embodiment of the present invention;

FIG. 2F shows a detailed view of a composite belt assembly for use in a band sealer mechanism as shown in FIG. 1 in accordance with a fourth embodiment of the present invention;

FIG. 2G shows a detailed view of a cross section of the composite belt assembly shown in FIG. 2F in accordance with the fourth embodiment of the present invention;

FIG. 2H shows a detailed view of a composite belt assembly for use in a band sealer mechanism as shown in FIG. 1 in accordance with a fifth embodiment of the present invention;

FIG. 2I shows a detailed view of a cross section of the composite belt assembly shown in FIG. 2H in accordance with the fifth embodiment of the present invention;

FIG. 2L shows a detailed view of a composite belt assembly for use in a band sealer mechanism as shown in FIG. 1 in accordance with a sixth embodiment of the present invention;

FIG. 2M shows a detailed view of a cross section of the composite belt assembly shown in FIG. 2L in accordance with the sixth embodiment of the present invention, and

FIG. 3 shows a flow chart illustrating a method for heat sealing a package in accordance with embodiments of the present invention.

### DETAILED DESCRIPTION

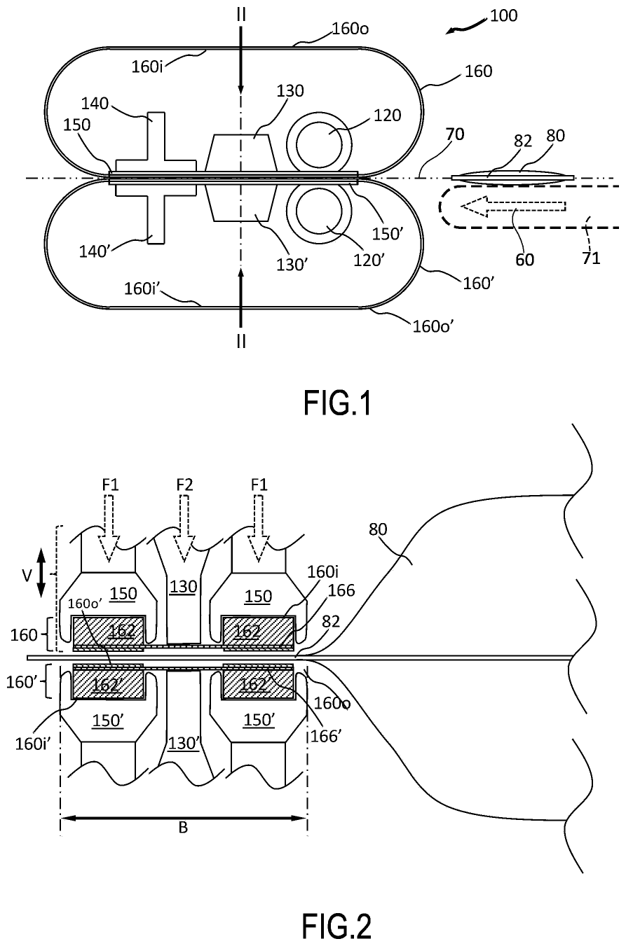

FIG. 1 schematically shows a side view of a band sealer 100 mechanism in accordance with embodiments of the present invention. Generally, the band sealer 100 is configured to receive, along a main movement direction 60, packages 80 containing one or more products to be packaged. Packages 80 include a bag neck 82 to be sealed by the band sealer 100. To this aim, packages 80 are moved with respect to the band sealer 100, typically by being placed on a conveyor belt or other transport device 71, such that the bag neck 82 of the packages 80 is fed into and through the band sealer 100 on a movement plane 70.

The band sealer 100 may include several components, such as one or more voiding devices, such as voiding rolls 120, 120′ configured to apply pressure to the packaging material of the bag neck 82 in order to expel, remove, or reduce any foreign matter from a region of the bag neck to be sealed. This typically improves the quality of the seal to be made by preventing foreign matter, for example particulate, fluids or liquids, or other material, from reducing an ability of the plastic material to bond during heat sealing. In some applications, such matter may come from the product to be packaged, in particular food products, such as meat or cheese, or when the product to be packaged is pourable (e.g. grain, flakes, muesli).

The band sealer 100 includes sealing elements 130, 130′, such as sealing blades (see FIG. 1) or sealing rolls (not shown). Sealing elements 130, 130′ are typically arranged opposite one another on either side of (e.g. above and below) the movement plane 70 of the packages 80. In this manner, the bag neck 82 of the packages 80 can be introduced into a gap between the sealing elements 130, 130′ in order to be heat sealed. This typically includes that one or both of the sealing elements 130, 130′ is moved relative to the other in order to get into close contact with the bag neck 82 for efficient and effective sealing. For example, in the band sealer 100 shown in FIG. 1, the upper sealing blade 130 may be configured to move vertically downwards towards the lower sealing blade 130′ for sealing a package 80. In this manner, a desired pressure may be applied to the bag neck 82 by the sealing blades 130, 130′ such that efficient heat transfer (e.g. heating) is achieved while friction between the sealing blades and the bag neck 82 is minimized or eliminated.

The band sealer 100 further includes cooling elements 140, 140′, such as cooling blades (see FIG. 1). Cooling elements 140, 140′ are, similar to sealing blades 130, 130′, typically arranged opposite one another on either side of (e.g. above and below) the movement plane 70 of the packages 80. In this manner, the bag neck 82 of the packages 80 can be introduced into a gap between the cooling elements 140, 140′ in order to be cooled after heat sealing has taken place. This typically includes that one or both of the cooling elements 140, 140′ is moved relative to the other in order to get into close contact with the bag neck 82 for efficient and effective cooling. For example, in the band sealer 100 shown in FIG. 1, the upper cooling blade 140 may be configured to move vertically downwards towards the lower cooling blade 140′ for cooling the seal on the bag neck of a package 80. In this manner, a desired pressure may be applied to the bag neck 82 by the cooling blades 140, 140′ such that efficient heat transfer (e.g. cooling) is achieved while friction between the cooling blades 140, 140′ blades and the bag neck 82 is minimized. In some examples, the cooling elements 140, 140′ and the sealing elements 130, 130′ are configured to move relative to their counterparts together, for example cooling blade 140 and sealing blade 130 may be configured to vertically move relative to cooling blade 140′ and sealing blade 130′, which may be fixedly installed with respect to the movement plane 70.

The band sealer 100 further includes belt assemblies 160, 160′ configured to grip, hold, and move the bag neck 82 of packages 80 into and through the band sealer 100 while the package 80 is being moved in movement direction 60. Each of the belt assemblies 160, 160′ is configured to form an endless loop that may be driven by one or more motors and guided by one or more wheels (not shown). It is understood that each of belt assemblies may exhibit an inner surface configured to engage with a motor-driven gear or sprocket in order to transfer the driving force onto the belt assembly 160, 160′.

The terms “inner” and “outer” surface are understood with respect to the loop shape of the respective belt assembly 160, 160′, such that an inner surface (e.g. a serrated surface) may engage a corresponding gear or wheel, and that an outer surface of the belt assembly 160, 160′ may contact the bag necks 82 of packages 80 being processed. Thus, the outer surfaces 160o, 160o′ of belt assemblies 160, 160′, as shown in FIG. 1, are configured to be in close proximity to or in (direct) contact with one another during normal operation. When processing packages 80, there are typically small gaps between packages rather than a continuous band of packages being fed through band sealer 100, so that at the respective gaps, the outer surfaces 160o, 160o′ of belt assemblies 160, 160′ are typically in direct contact to one another. Likewise, the inner surfaces 160i, 160i′ of belt assemblies 160, 160′, as shown in FIG. 1, are configured to engage a corresponding gear, roll, and/or sprocket (not shown) during normal operation.

It is understood that band sealer 100 further comprises a control unit (not shown) connected to a plurality of components of band sealer 100 in order to control operation of the band sealer 100 and its individual components. For example, the control unit is connected to one or more motors configured to drive belt assemblies 160, 160′ or configured to actuate one or more components (e.g. sealing blades, guides). Further, the control unit is connected to sealing blades 130, 130′ and configured to control a heating power applied to the sealing blades 130, 130′. Typically, sealing blades 130, 130′ are electrically powered such that an operating temperature of sealing blades 130, 130′ can be accurately controlled, in particular with respect to the properties of the packaging material of packages 80. It is noted that the control unit is configured to control the operating parameters of the band sealer 100 and that, for reasons of clarity, the control unit and individual connections, as well as further components (e.g. power source, motor drives, actuators) and connections between the control unit and the components are not shown in FIG. 1.

In some embodiments, pressure rolls (not shown in FIG. 1) may be provided, for example located, in movement direction 60, between sealing blades 130, 130′ and cooling blades 140, 140′. The pressure rolls, which may be similar to voiding rolls 120, 120′, are configured to exert pressure on the packaging material, after the material has been heat-treated by sealing blades 130, 130′. Pressure rolls are configured to firmly press the packaging material together, while the material is still (residually) compliant from heat treatment. This may further improve or optimize the quality of the resulting seal, before cooling blades 140, 140′ cool down, cure and/or otherwise solidify the seal.

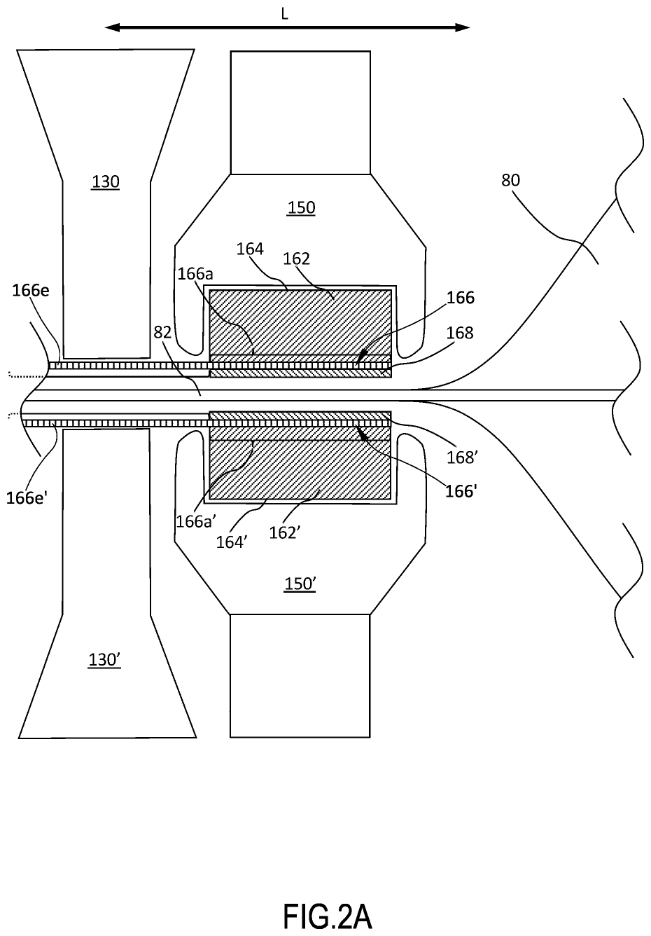

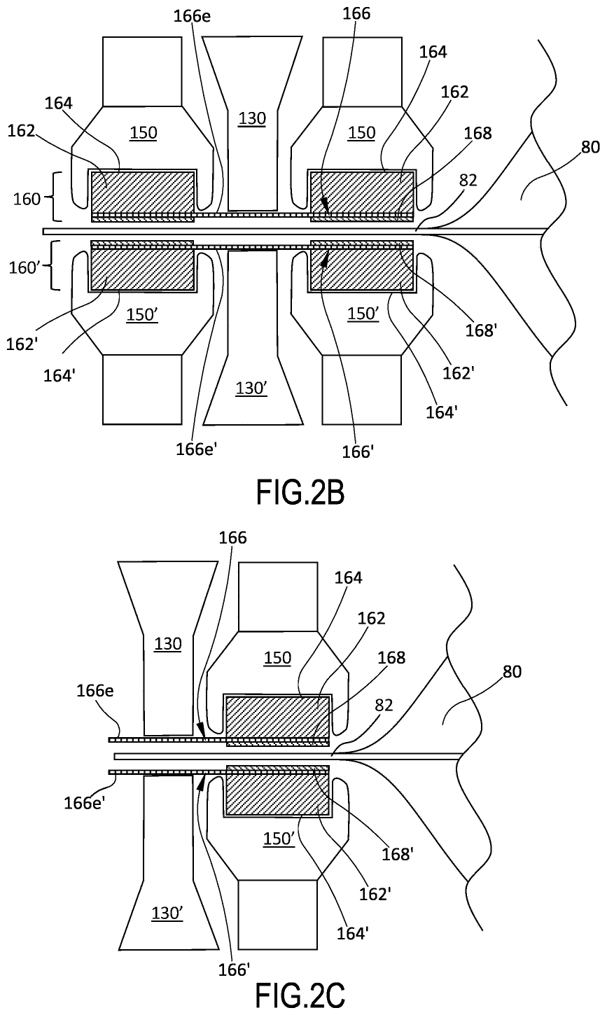

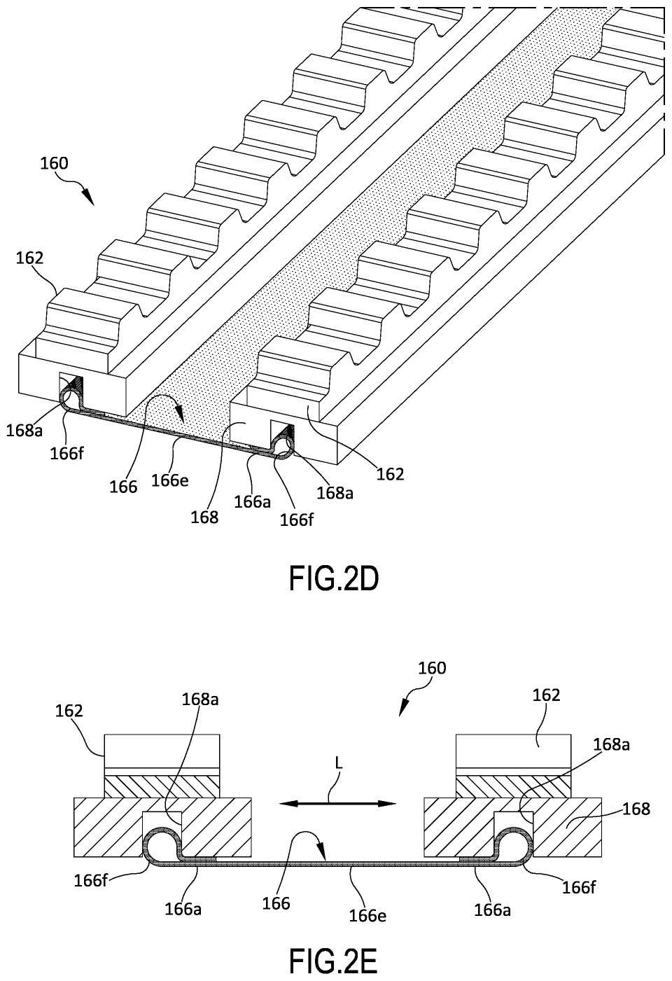

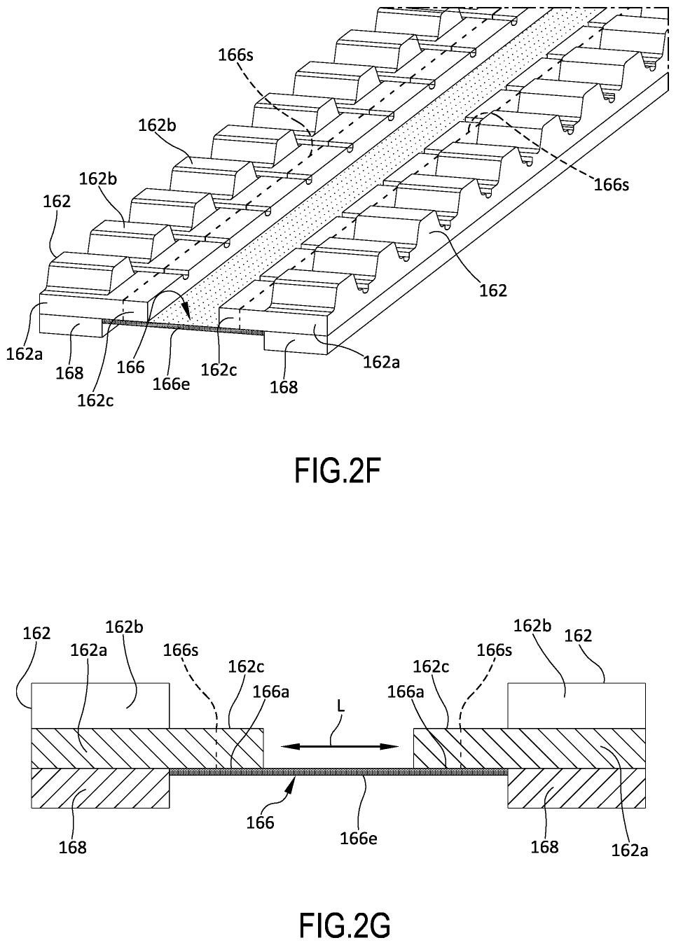

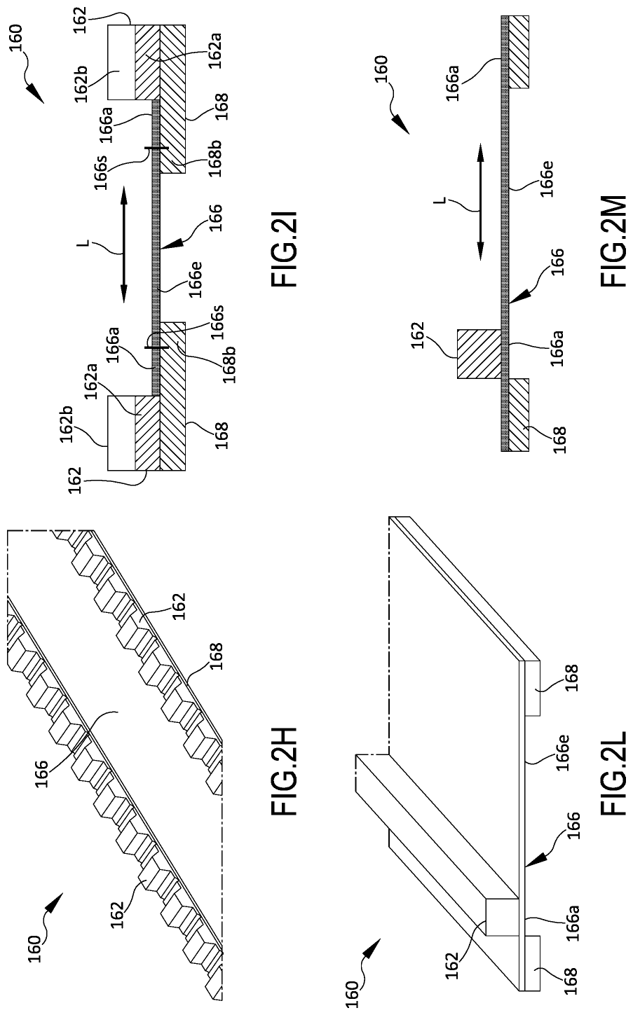

FIG. 2 shows a cross section (II-II) of the band sealer 100 mechanism shown in FIG. 1 in accordance with embodiments of the present invention. In the embodiment shown in FIG. 2, the band sealer 100 comprises belt assemblies 160, 160′ each including two sets of main belts 162, 162′ connected to one another by a respective layer 166, 166′. The composition of belt assemblies 160, 160′ is described in detail further below with respect to FIGS. 2A, 2B, 2C, 2D, 2E, 2F, and 2G.

With respect to FIGS. 2, 2A, 2B, and 2C it is noted that for reasons of clarity, there is a gap or space shown between the bag neck 82 of the package 80 and the belt assemblies 160, 160′. It is noted that this schematic representation is merely intended for illustrating the structural features of the elements involved and that, in operation, the belt assemblies 160, 160′, the sealing blades 130, 130′, and other components are in close proximity to one another, in direct contact with one another, and/or in contact with the packaging material of bag neck 82 of package 80. As described, the band sealer 100 is configured to apply first F1 and second F2 forces to the packaging material of the bag neck 82 of packages 80, which requires contact between, for example, the belt assemblies 160, 160′ and the packaging material (see first force F1) and the sealing blades 130, 130′ and the packaging material (via the first layer 166, 166′; see F2).

Band sealer 100 further comprises guides 150, 150′ configured to respectively guide belt assemblies 160, 160′ and to receive any lateral forces exerted on belt assemblies 160, 160′, for example by shrinking and/or deformation of packaging material of back neck 82 and/or package 80. Guides 150, 150′ may be arranged vertically movable (see direction V) with respect to one another.

In the embodiment shown in FIG. 2, guides 150 are configured to vertically move relative to guides 150′, which are fixedly installed, in order to allow for belt assembly 160 to be moved in close proximity to or in direct contact with belt assembly 160′. F1 denotes a first force with which guides 150 and, thus, belt assembly 160, may exert on the bag neck 82 of packages 80 being processed. As described above, sealing blade 130 may be similarly vertically movable (independently from guides 150) in order to control a pressure F2 exerted by sealing blade 130 onto the bag neck 82 of packages 80. The first force F1 typically ranges from 20 to 800 N, preferably 50 to 350 N. The second force F2 typically ranges from 20 to 350 N, preferably from 30 to 300 N. A third force F3 (not shown in the figures) exerted by cooling blades 140, 140′ onto the bag neck 82 of packages 80 (in a manner substantially similar to that of the second force F2 exerted by sealing blades 130, 130′) typically ranges from 20 to 350 N, preferably from 30 to 300 N. In a preferred embodiment, the second force F2 is about 75 N and the third force F3 is about 55 N. It is understood that both opposite belt assemblies 160, 160′ and guides 150, 150′ either exert the first force F1 (e.g. when being actuated to move relative to their counterpart) or receive and support the first force F1 (when receiving such force from an actuated counterpart). The same applies to blades 130′ and 140′.

As mentioned above, band sealer 100 is provided with corresponding actuators connected to the control unit, which is configured to control the actuators in order to individually actuate the corresponding components in a controlled manner. In some embodiments, a width B of the arrangement of guides 150, 150′ and sealing blades 130, 130′ ranges from 10 to 30 mm, preferably from 15 to 25 mm, more preferred from 18 to 22 mm.

FIG. 2A shows a detailed view of a cross section of the band sealer 100 mechanism shown in FIG. 1 in accordance with embodiments of the present invention. FIG. 2A shows a detailed view of the composition of belt assemblies 160, 160′. Generally, both belt assemblies 160, 160′ have the same composition, unless otherwise specified.

A belt assembly 160, 160′ includes at least one main belt 162, 162′ (e.g. a timing belt, cam belt, or toothed belt, for example a type T5 belt manufactured by breco; also in some embodiments, a Forbo Siegling Belt T5 PAZ may be used) configured to substantially carry the belt assembly and configured for synchronizing/timing purposes. In some embodiments, each belt assembly 160 and/or 160′ is provided with only a single main belt 162, 162′ (see, e.g. FIGS. 2C, 2L and 2M), while in other embodiments, each belt assembly 160 and/or 160′ is provided with two main belts 162, 162′ (see, e.g., FIG. 2, 2A, 2B, 2D, 2E, 2F, 2G, 2H, 2I). The belt assembly 160, 160′ further includes a first layer 166, 166′ fixedly attached to the main belt 162, 162′ and a second layer 168, 168′ fixedly attached to the first layer 166, 166′. The first layer may alternatively be directly and fixedly attached to the second layer, with this latter being attached to the main belt.

The first layer 166, 166′ is configured to laterally (see direction “L” in FIG. 2A) extend beyond the main belt 162, 162′ such that the layer extends over the sealing blades 130, 130′. In some embodiments, the first layer 166, 166′ extends between two main belts 162, 162′ (see e.g. FIG. 2) such that the first layer 166, 166′ is held in place by the two main belts 162, 162′, respectively covering the sealing blades 130, 130′.

The first layer 166, 166′ is configured to exhibit good heat transfer properties, such that heat applied to bag neck 82 of a package 80 from sealing blades 130, 130′ can be efficiently transferred through the first layer 166, 166′. This facilitates efficient and effective heat sealing by means of heat applied by sealing blades 130, 130′ due to high heat conduction properties of the material or materials of the first layer 166, 166′. Further, the first layer 166, 166′ is configured to exhibit a very low resistance with respect to friction with the sealing blades 130, 130′. This facilitates that even under relative pressure (see F1 in FIG. 2), the friction between the moving first layer 166, 166′ and the stationary sealing blade 130, 130′ remains relatively low.

In some embodiments, the first layer 166, 166′ includes polytetrafluoroethylene, a Teflon-fiberglass tape, band, or film, which provides both very good heat conduction and very low friction or resistance. In some embodiments, the first layer may include CF206 from Saint Gobain, which is a highly consolidated PTFE-coated glass fabric with an extra glossy and smooth non-stick surface. In these and/or other embodiments, the first layer 166, 166′ may exhibit a PTFE weight % content of between 50% and 80%, preferably about 65%, a thickness of between 0.05 mm and 0.4 mm, preferably between 0.1 mm and 0.2 mm, more preferably about 0.140 mm, a tensile strength of between 250 N/cm and 300 N/cm, preferably about 260 N/cm to 280 N/cm, and/or a tear strength of between 12 N and 20 N, preferably about 16 N, all in accordance with test method FTMS 191A-5102.

The second layer 168, 168′ is configured to provide a contact surface for the bag neck 82 of package 80 which exhibits a friction coefficient sufficiently high for the second layer 168, 168′ to firmly grip, hold, and move the packaging material into and through band sealer 100. In some embodiments, the second layer 168 includes silicone. In other embodiments, the second layer 168, 168′ may include use Linatex from Forbo Siegling, preferably as lining on the T5 timing belt. The second layer has a thickness of between 0.5 mm and 2 mm, preferably between 0.75 mm and 1.5 mm, more preferably about 1 mm.

In some embodiments, the belt assembly 160, 160′ further includes a third layer 164 fixedly attached to the main belt 162, 162′ opposite from the first layer 166, 166′. The third layer is configured to provide the main belt 162, 162′ with a contact surface towards the guides 150, 150′ which allows the guides 150, 150′ to guide the main belt 162, 162′ and to exert the first force F1 upon the main belt 162, 162′ (or to support the main belt 162, 162′ when receiving such force) while maintaining relatively low friction. Maintaining a low friction coefficient between the guides 150, 150′ and the belt assemblies 160, 160′ serves to facilitate efficient and effective operation of the band sealer 100, in particular the driving of the belt assemblies 160, 160′ by one or more electric motors or drives.

In some embodiments, the third layer 164, 164′ includes a mesh material fixedly attached to the main belt 162, 162′. In other embodiments, the third layer 164, 164′ may include an Eco-mesh coating of Forbo Siegling, preferably to reduce friction on the T5 belt.

The second 168, 168′ and third 164, 164′ layers have substantially the same width as the main belt 162, 162′. In some embodiments the width of the main belt 162, 162′ (and, thus, of the second 168, 168′ and third 164, 164′ layers) ranges between 3 and 15 mm, preferably between 5 and 12 mm, more preferably between 6 and 8 mm.

As shown in FIG. 2A, the first layer 166, 166′ is configured to laterally (see direction “L” in FIG. 2A) extend beyond the main belt 162, 162′ such that the layer extends over the sealing blades 130, 130′. The first layer 166, 166′ includes an attachment portion 166a, 166a′ configured to provide an attachment to both the main belt 162, 162′ and the second layer 168, 168′. The first layer 166, 166′ further includes an extension portion 166e, 166e′ laterally extending beyond the main belt 162, 162′ towards the sealing blades 130, 130′. The extension portion 166e, 166e′ is configured to cover sealing blades 130, 130′ or, in other words, to be positioned between the sealing blades 130 and 130′, thereby being interposed between each sealing blade 130, 130′ and the bag neck 82 of a package 80 to be processed.

Typically, the extension portion 166e, 166e′ of the first layer 166, 166′ has a width substantially similar to the width of the attachment portion(s) 166a, 166a′ of the first layer 166, 166′. In some embodiments, the extension portion 166e, 166e′ of the first layer 166, 166′ has a width of about 5 to 10 mm, preferably of about 6 to 9 mm, more preferably of about 8 mm.

FIG. 2B shows a detailed view of a cross section (II-II) of the band sealer 100 mechanism shown in FIG. 1 in accordance with a first embodiment of the present invention. In this first embodiment, the belt assemblies 160, 160′ each include (see enlarged FIG. 2A for reference numerals) two main belts 162, 162′ and two second layers 168, 168′, as well as, optionally, two third layers 164, 164′.

Each belt assembly 160, 160′ further includes a single first layer 166, 166′, respectively. Each first layer 166, 166′ is fixedly attached to both main belts 162, 162′, such that the first layer 166, 166′ laterally extends from one main belt 162, 162′ to the other main belt 162, 162′. The single first layer 166, 166′ further comprises, at each lateral side thereof, an attachment portion 166a, 166a′, which are connected by a single extension portion 166e, 166e′. The single extension portion 166e, 166e′ is arranged to extend over a corresponding sealing blade 130, 130′ when installed in a band sealer 100.

What has been described above, in particular with respect to FIGS. 2 and 2A, is also applicable to the first embodiment shown in FIG. 2B, for example the presence and configuration of different layers, the manner in which layers are attached to one another and/or the main belt 162, 162′, and other elements, unless specifically states otherwise.

The belt assembly 160, 160′ in accordance with the first embodiment allows for the two main belts 162, 162′, side by side arranged opposite one another, to more reliably grip and hold the bag neck 82 of a package 80 being processed by band sealer 100. This configuration allows for the heat sealing being achieved in a region between the two pairs of belts 162, 162′ such that any shrinking and/or deformation of the bag neck 82 and/or the package 80 due to heat sealing may be reduced or prevented. In particular, the portions of the bag neck 82 being gripped by belt assemblies 160, 160′ and the remaining portions of package 80 will be effectively shielded from any shrinking and/or deformation taking place between the two pairs of belts 162, 162′. This principle is applicable to the entire processing, including voiding (see voiding wheels 120, 120′), heat sealing (see above), and/or cooling (see cooling blades 140, 140′), as the packages 80 move along the movement plane 70 in main movement direction 60.

At the same time, the first layer 166, 166′ is, during processing along movement plane 70, both in contact with the bag neck 82 of packages 80, such that the heat applied to the first layer 166, 166′ by sealing blades 130, 130′ is well conducted through the first layer 166, 166′ and to the bag neck 82 of packages 80. Due to the properties of the material of the first layer 166, 166′, the direct (moving) contact between the (stationary) sealing blades 130, 130′ and the first layer 166, 166′ is achieved with minimal friction, such that even higher second forces F2 may be applied to the sealing blades 130, 130′ (e.g. in order to optimize heat sealing and/or heat transfer) without creating excessive friction and/or stress on the first layer 166, 166′ and/or on the material of the bag neck 82 of packages 80.

FIG. 2C shows a detailed view of a cross section (II-II) of the band sealer mechanism shown in FIG. 1 in accordance with a second embodiment of the present invention. In this second embodiment, the belt assemblies 160, 160′ each include (see enlarged FIG. 2A for reference numerals) one main belt 162, 162′, one first layer 166, 166′, and one second layer 168, 168′, as well as, optionally, one third layer 164, 164′.

The second embodiment differs from the first embodiment in that there is provided only one main belt 162, 162′ instead of two and in that the first layer does not extend between two main belts but laterally extends from the one main belt 162, 162′ as shown in FIG. 2C. This facilitates a simpler design of the belt assemblies 160, 160′ while similar advantages as described above are realized. Propagating of potential shrinking and/or deformation of the packaging material of the bag neck 82 towards or into the package 80 during processing is reduced or entirely prevented by the belt assemblies 160, 160′ firmly gripping, holding, and moving the bag neck 82 of packages into and through the band sealer 100.

FIG. 2D shows an isometric view of a composite belt assembly 160 for use in a band sealer mechanism as shown in FIG. 1 in accordance with a third embodiment of the present invention. Generally, the belt assemblies in accordance with the third and fourth embodiments may be employed as shown above with respect to FIGS. 1, 2, 2A, and 2B, while the particular composition and/or assembly of the respective composite belt assembly may be different.

FIG. 2E shows a detailed view of a cross section of the composite belt assembly 160 shown in FIG. 2D in accordance with the third embodiment of the present invention. As shown in FIGS. 2D and 2E, the belt assembly 160 in accordance with the third embodiment exhibits a main belt 162, which may be a toothed main belt (e.g. a timing belt or a cam belt), and a second layer 168 as described above. In the example of FIGS. 2D and 2E, the second layer may however have a width same or larger (FIG. 2E) than the width of the main belt 162. The first layer 166 is fixed to the second layer 168 by a respective loop 166f of the attachment portion 166a: the loop 166f is set into a respective recess 168a in the second layer 168 as shown in FIG. 2E. Here, the attachment material of the attachment portion 166a of the first layer 166 may be shaped (e.g. folded) in a manner allowing for the material to be set into (e.g. pushed, pressed) the recess in the second layer 168 under interference. In practice, rigidity and the elastic return force exerted by the folded material keeps the loops 166f in the recess under a certain interference caused by the friction between the folded material at the loop 166f and the recess wall of the second layer 168. In this manner, the first layer may be fixedly attached to the second layer 168 and, thus, to the remaining elements of the composite belt assembly. In the example of FIGS. 2D and 2E, the belt assembly 160 includes a first layer 166 configured to laterally (see direction “L”) extend beyond the main belt 162 such that the first layer may in use extend over the sealing blades 130, 130′. In particular, the first layer 166 extends between two laterally spaced main belts 162, both in form of a toothed endless belt, and have opposite attachment portions 166a fixed to a respective second layer 168 which is in the shape of a band extending along the respective main belt 162. In the example of FIGS. 2D and 2E, the first layer is relatively thin and in any case has thickness sensibly smaller than that of each of the main belt and second layer.

FIG. 2F shows an isometric view of a composite belt assembly for use in a band sealer mechanism as shown in FIG. 1 in accordance with a fourth embodiment of the present invention. FIGS. 2F and 2G illustrate a fourth embodiment of a composite belt assembly that may be employed as shown above with respect to FIGS. 1, 2, 2A, and 2B.

FIG. 2G shows a detailed view of a cross section of the composite belt assembly shown in FIG. 2F in accordance with the fourth embodiment of the present invention. As shown in FIGS. 2F and 2G, the belt assembly in accordance with the fourth embodiment exhibits a main belt 162 (e.g. a timing belt or a cam belt): the main belt 162 may be a toothed endless main belt comprising a base body 162a in the form of a band extending endlessly along the composite belt 160 and toothed projections 162b emerging from the base body 162a. The belt assembly 160 also includes a first layer 166 and a second layer 168 as described above. The first layer 166 is, in this case, indirectly fixed to the second layer 168 by stitching 166s set into a respective laterally extending portion 162c of the base body 162a of the main belt 162. Note that, although in FIGS. 2F and 2G, the first layer extends in the lateral direction of arrow L to terminally touch a side of the second layer, the first layer may alternatively laterally extend to overlap with said extending portion 162c without contacting the second layer 168. Moreover, in the example shown in FIGS. 2F and 2G, the belt assembly 160 includes a first layer 166 configured to laterally (see direction “L”) extend beyond the main belt base body 162a such that the first layer may in use extend over the sealing blades 130, 130′. In particular, the first layer 166 extends between two laterally spaced main belts 162 (preferably identical) and have opposite attachment portions 166a fixed to a respective extending portion 162c of a respective main belt 162. Furthermore, in the example of FIGS. 2F and 2G, the first layer is relatively thin and in any case has thickness sensibly smaller than that of each of the main belt and second layer. The attachment portions 166a of the first layer 166 overlap with the extending portions 162 of the main belts 162, such that the material of the first layer 166 may be fixedly attached to the main belt, for example by stitching 166s. Alternatively or additionally, the first layer may be fixedly attached to the main belt by gluing, bonding, heat treatment, and/or other means. In this manner, the first layer may be fixedly attached to the main belt 162 and, thus, to the remaining elements of the composite belt assembly.

FIG. 2H shows an isometric view of a composite belt assembly for use in a band sealer mechanism as shown in FIG. 1 in accordance with a fifth embodiment of the present invention. FIGS. 2H and 2I illustrate a fifth embodiment of a composite belt assembly that may be employed as shown above with respect to FIGS. 1, 2, 2A, and 2B.

FIG. 2I shows a detailed view of a cross section of the composite belt assembly shown in FIG. 2H. As shown in FIGS. 2H and 2I, the belt assembly 160 in accordance with the fifth embodiment exhibits a main belt 162 (e.g. a timing belt or a cam belt): the main belt 162 may be a toothed endless main belt comprising a base body 162a in the form of a band extending endlessly along the composite belt 160 and toothed projections 162b emerging from the base body 162a. The belt assembly 160 also includes and a first layer 166 and a second layer 168 as described above. The first layer 166 is, in this case, directly fixed to the second layer 168 by stitching 166s set into a respective laterally extending portion 168b of the second layer 168. Note that, although in FIGS. 2H and 2I, the first layer extends in the lateral direction of arrow L to terminally touch a side of the main body 162, the first layer may alternatively laterally extend to overlap with said extending portion 168b of the second layer 168 without contacting the main body 162. Moreover, in the example shown in FIGS. 2H and 2I, the belt assembly 160 includes a first layer 166 configured to laterally (see direction “L”) extend beyond the extending portion 168b of the second layer such that the first layer may in use extend over the sealing blades 130, 130′. In particular, the first layer 166 extends between two laterally spaced main belts 162 (preferably identical) and have opposite attachment portions 166a fixed to a respective extending portion 168b of the second layer 168. Furthermore, in the example of FIGS. 2H and 2I, the first layer is relatively thin and in any case has thickness sensibly smaller than that of each of the main belt and second layer. The attachment portions 166a of the first layer 166 overlap with the extending portions 168b of the second layers, such that the material of the first layer 166 may be fixedly attached to the second layers, for example by stitching 166s. Alternatively or additionally, the first layer may be fixedly attached to the second layers by gluing, bonding, heat treatment, and/or other means. In this manner, the first layer may be fixedly attached to the second layer and to the main belt 162.

FIG. 2L shows an isometric view of a composite belt assembly for use in a band sealer mechanism as shown in FIG. 1 in accordance with a sixth embodiment of the present invention. FIGS. 2L and 2M illustrate a sixth embodiment of a composite belt assembly that may be employed as shown above with respect to FIGS. 1, 2, 2A, and 2B.

FIG. 2M shows a detailed view of a cross section of the composite belt assembly shown in FIG. 2L. As shown in FIGS. 2L and 2M, the belt assembly 160 in accordance with the sixth embodiment exhibits a main belt 162 (e.g. a timing belt or a cam belt): the main belt 162 may be a toothed endless main belt or a belt without teeth in the form of a band extending endlessly along the composite belt 160. The belt assembly 160 also includes and a first layer 166 and a second layer 168 as described above. The first layer 166 is, in this case, directly fixed to the main belt and to the second layer 168: in practice the attachment portion 166a of the first layer is on one side fixed to the main body 162 and on the opposite side to the second layer 168. Note that, although in FIGS. 2L and 2M, the first layer extends in the lateral direction of arrow L to completely overlap the second layer 168, the first layer may alternatively laterally extend to only partially overlap the second layer 168. Moreover, in the example shown in FIGS. 2M and 2L, the belt assembly 160 includes a first layer 166 configured to laterally (see direction “L”) extend beyond the second layer such that the first layer may in use extend over the sealing blades 130, 130′. In particular, the first layer 166 extends between two laterally spaced second layers 168 (preferably identical) and have opposite attachment portions 166a fixed to a respective one of the two second layers 168, which may be two identical bands running all along the belt assembly 160. Furthermore, in the example of FIGS. 2M and 2L, the first layer is relatively thin and in any case has thickness sensibly smaller than that of each of the main belt and second layer. The attachment portions 166a of the first layer 166 overlap with the second layers, such that the material of the first layer 166 may be fixedly attached to the second layers, for example by stitching, gluing, bonding, heat treatment, and/or other means. In this manner, the first layer may be fixedly attached to the second layer. The first layer is also attached to the main belt 162 using any one of the above described means. In the example of FIGS. 2M and 2L the main belt is laterally shifted relative to the underlying second layer band 168: alternatively the main belt 162 and the respective second layer may be perfectly overlapping and aligned along one side of the belt assembly. Furthermore two symmetrically positioned (and preferably identical) main belts 162 may be provided as in the previous embodiments.

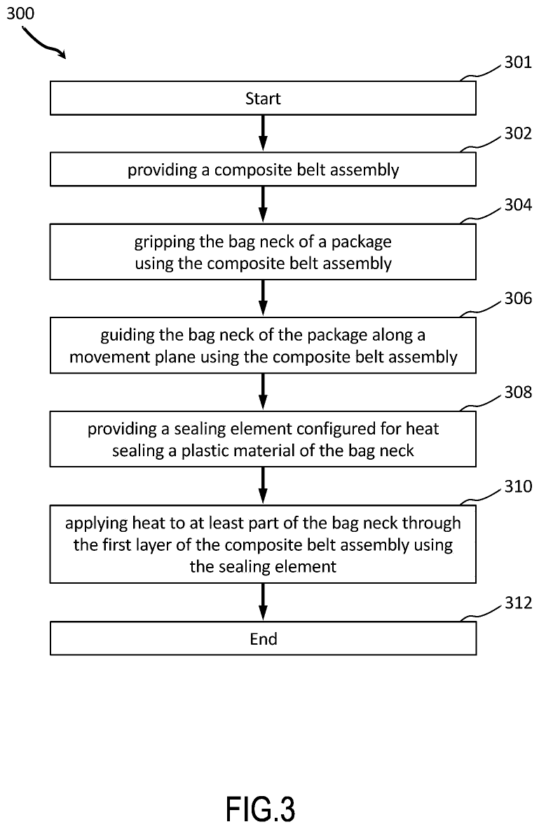

FIG. 3 shows a flow chart illustrating a method 300 for heat sealing a package in accordance with embodiments of the present invention. The method 300 starts at step 301. At step 302, a composite belt assembly 160, 160′ as described above is provided. At step 304, the bag neck 82 of a package 80 to be sealed is gripped using the composite belt assembly 160, 160′. At step 306, the bag neck 82 of the package 80 is guided along the movement plane 70 using the composite belt assembly 160, 160′. At step 308, a sealing element 130, 130′, for example sealing blades, configured for heat sealing the plastic material of the bag neck 82 is provided. At step 310, heat is applied to at least part of the bag neck 82 through the first layer 166, 166′ of the composite belt assembly 160, 160′ using the sealing element 130, 130′. The process ends at step 312.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and the scope of the appended claims.

1. A composite belt assembly for a band sealer (100), comprising a belt (160, 160′), the belt (160, 160′) comprising:
a main belt (162, 162′);
a first layer (166, 166′); and
a second layer (168, 168′); wherein
the first layer (166, 166′) is arranged in contact with at least one of the main belt (162, 162′) and the second layer (168, 168′); and
the first layer (166, 166′) includes an attachment portion (166a, 166a′) connected to at least one of the main belt (162, 162′) and the second layer (168, 168′).

2. The composite belt assembly of claim 1, wherein the first layer (166, 166′) further includes an extended portion (166e, 166e′), configured to laterally extend beyond the main belt (162, 162′) and the second layer (168, 168′) with respect to a longitudinal extension of the main belt (162, 162′).

3. The composite belt assembly of claim 1, wherein the first layer (166, 166′) is fixedly attached to the main belt (162, 162′) or to the second layer (168, 168′) by one or more of heat bonding, gluing, and stitching.

4. The composite belt assembly of claim 1, wherein the second layer (168, 168′) is fixedly attached to the first layer (166, 166′) by one or more of heat bonding, gluing, and/or stitching.

5. The composite belt assembly of claim 1, wherein the main belt (160, 160′) exhibits a shape of an endless loop, wherein the main belt (160, 160′) has an inner surface and an outer surface with respect to the shape of the endless loop; and wherein one of the second layer (168, 168′) and of the first layer (166, 166′) is arranged on the outer surface of the main belt (162, 162′).

6. The composite belt assembly of claim 5, wherein the first layer (166, 166′) is directly attached to the outer surface of the main belt (162, 162′) and wherein the second layer (168, 168′) is directly attached to an outer surface of the first layer (166, 166′).

7. The composite belt assembly of claim 5, wherein the first layer (166, 166′) is directly attached to the outer surface of the main belt (162, 162′), at a laterally extending portion (162c) of a base body (162a) of the main belt, and wherein the second layer (168, 168′) is directly attached to an outer surface of the main belt (162, 162′), at a location adjacent said laterally extending portion.

8. The composite belt assembly of claim 5, wherein the second layer (168, 168′) is directly attached to the outer surface of the main belt (162, 162′) and the first layer (166, 166′) is directly attached to an outer surface of the second layer (168, 168′).

9. The composite belt assembly of claim 5, wherein the second layer (168, 168′) is directly attached to the outer surface of the main belt (162, 162′) and the first layer (166, 166′) is directly attached to an inner surface of the second layer (168, 168′).

10. The composite belt assembly of claim 1, wherein the first layer (166, 166′) comprises a thin elongated web and wherein the second layer (168, 168′) comprises an elongated band with thickness greater than a thickness of the first layer elongated web.

11. (canceled)

12. The composite belt assembly of claim 1, further comprising an additional second layer (168, 168′) laterally spaced from said second layer (168, 168′).

13. (canceled)

14. The composite belt according to claim 12, wherein the first layer (166, 166′) includes an additional attachment portion (166a, 166a′) on an opposite side of the first layer (166, 166′) with respect to the attachment portion (166a, 166a′), the additional attachment portion being connected to the additional second layer (168, 168′), and
wherein the extended portion (166e, 166e′) laterally extends between the second layer and the additional second layer.

15. (canceled)

16. (canceled)

17. The composite belt assembly of claim 14 further comprising an additional main belt (162, 162′), wherein:
the additional attachment portion (166a, 166a′) of the first layer (166, 166′) contacts the additional main belt (162, 162′) and/or the additional second layer (168, 168′);
the first layer (166, 166′) is arranged between the additional second layer (168, 168′) and the additional main belt (162, 162′);
the additional attachment portion (166a, 166a′) of the first layer (166, 166′) contacts the additional main belt (162, 162′) and the additional second layer (168, 168′); and
the extended portion (166e, 166e′) laterally extends between the main belt (162, 162′) and the additional main belt (162, 162′).

18. (canceled)

19. The composite belt assembly of claim 1, wherein the first layer (166, 166′) includes polytetrafluoroethylene (PTFE), Teflon, a Teflon band, Teflon tape, or Teflon film.

20. The composite belt assembly of claim 1, wherein the first layer (166, 166′) provides higher heat conduction than the second layer and the first layer (166, 166′) provides for lower static friction on a smooth plastic surface than the second layer.

21. (canceled)

22. (canceled)

23. The composite belt assembly of claim 1, wherein the belt assembly (160, 160′) further comprises a third layer (164, 164′) attached to the main belt (162, 162′) on an inner surface of the main belt opposite the first layer (166, 166′).

24. (canceled)

25. The composite belt assembly of claim 23, wherein the third layer (164, 164′) includes a mesh structure, wherein the third layer (164, 164′) provides the main belt (162, 162′) with a low friction surface, wherein the third layer (164, 164′) provides for lower static friction on a smooth metal surface than the main belt (162, 162′).

26. (canceled)

27. (canceled)

28. (canceled)

29. (canceled)

30. (canceled)

31. A packaging line comprising a band sealer (100) comprising a composite belt assembly (160, 160′), the belt assembly (160, 160′) comprising:
a main belt (162, 162′);
a first layer (166, 166′); and
a second layer (168, 168′); wherein
the first layer (166, 166′) is arranged in contact with at least one of the main belt (162, 162′) and the second layer (168, 168′); and
the first layer (166, 166′) includes an attachment portion (166a, 166a′) connected to at least one of the main belt (162, 162′) and the second layer (168, 168′); the packaging line comprising one or more of:
a feeding station configured to provide packages (80);
at least one conveyor, in particular a conveyor belt, (71) configured to convey the packages (80) along a main movement direction (60) from the feeding station to the band sealer; and,
a vacuum station configured to evacuate the packages (80) and/or to provide the packages (80) with a controlled internal atmosphere.

32. A method (300) of heat sealing a package (80), comprising:
providing (302) a composite belt assembly (160, 160′) comprising a belt (160, 160′), the belt assembly (160, 160′) comprising:
a main belt (162, 162′);
a first layer (166, 166′); and
a second layer (168, 168′); wherein
the first layer (166, 166′) is arranged in contact with at least one of the main belt (162, 162′) and the second layer (168, 168′); and
the first layer (166, 166′) includes an attachment portion (166a, 166a′) connected to at least one of the main belt (162, 162′) and the second layer (168, 168′);
gripping (304) a bag neck (82) of the package (80) using the composite belt assembly (160, 160′);
guiding (306) the bag neck (82) of the package (80) along a movement plane (70) using the composite belt assembly (160, 160′);
providing (308) a sealing element (130, 130′) configured for heat sealing a plastic material of the bag neck (82); and
applying (310) heat to at least part of the bag neck (82) through the first layer (166, 166′) of the composite belt assembly (160, 160′) using the sealing element (130, 130′).

33. (canceled)

34. (canceled)

35. (canceled)

36. (canceled)
